(19) United States
(12) Patent Application Publication
(10) Pub. No.: US 2006/0090792 A1
(43) Pub. Date: May 4, 2006

(54) Multiaxial vibration valve

(76) Inventor: Richard Tamian, Sparta, NJ (US)

Correspondence Address: RICHARD TAMIAN, 69 EDISON TERRACE, SPARTA, NJ, 07871, US

(21) Appl. No.: 10/979,459

(22) Filed: Nov. 2, 2004

(51) Int. Cl. F16K 17/36

(52) U.S. Cl. 137/38

(57) ABSTRACT

The multiaxial vibration valve of the invention is a stand alone device that operates in any axial plane to regulate the flow of a fluid when the invention is vibrated by an outside source, wherein the multiaxial vibration valve comprises a flow chamber (21) with an inlet port (22) and an outlet port (23), a valve seat (25) between the lower interior volume of the flow chamber and said outlet port, a control ball (24), in moveable engagement with said valve seat, and a compressional spring (27), such that said spring holds the control ball up against said valve seat forming a seal which prevents any fluid to flow from the flow chamber to the outlet port when said valve device is at rest in a non vibrating stable condition, and has a spring compressional force value such that it allows said control ball to become dislodged from the valve seat when the valve device is accelerated by oscillations and vibrations from an outside source, which allows fluid present in the flow chamber to flow past the control ball through the valve seat and then through the outlet port, wherein when said device ceases to vibrate, said compression spring working in conjunction with the curved lower portion of the flow chamber (26), automatically repositions the control ball to the valve seat, restoring said seal, whereby preventing the flow of the fluid.

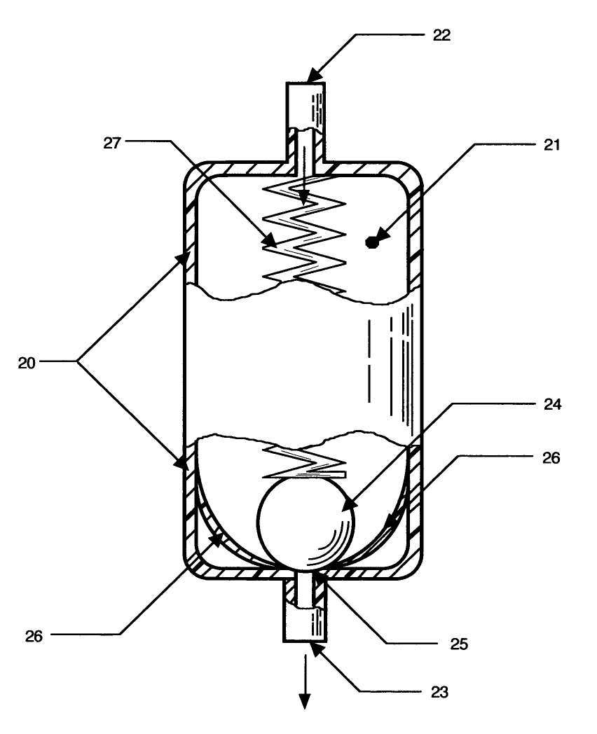

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF INVENTION

This invention relates to a device that regulates the flow of a fluid to periods during which the device is vibrated by an outside influence. The invention is based on the realization that the vibration present in many mechanical devices can control a vibration valve when the mechanical device is operating, such that fluid can flow through the vibration valve when the mechanical device is operating and can be automatically restricted when the mechanical device is not operating. My former invention, U.S. Pat. No. 6,601,601 to Tamian (2003), that makes use of this type of vibration valve, functions normally only in the vertical position and can not operate to restrict the fluid flow when placed in line in any other direction off the vertical plane. My new invention, the multiaxial vibration valve, can operate as an in line, fluid flow control device when positioned in any directional plane.

### BRIEF SUMMARY OF THE INVENTION

The multiaxial vibration valve of the invention is a simple but effective device to regulate the flow of a fluid when the valve is vibrated by an outside source, and automatically stops the flow of the fluid when the mechanical outside device is turned off, thus not requiring the generation of any other control signals or the intervention of a human operator.

The multiaxial vibration valve according to the invention comprises an inlet port connected to a flow chamber that is connected to an outlet port. A valve seat is located between the lower part of the flow chamber and said outlet port. A compressional spring is connected between the upper section of the flow chamber to the control ball.

The invention relies on vibrations to accelerate a control ball which cooperates with said valve seat and said compressional spring such that the acceleration of the control ball causes it to move out of engagement with said valve seat allowing fluid to flow from the flow chamber, around the control ball, through the valve seat, and then through the outlet port. When no vibration is present, the control ball is held stable against said valve seat by the compressional force of said spring whereby, forming a seal at the contact between the control ball and said valve seat, thus preventing fluid in the flow chamber in flowing to the outlet port.

My multiaxial vibration valve is a stand alone, self contained unit that can operate in all axial positions, making it more versatile for an inline fluid flow control device. Other advantages and essential details of the invention will become apparent from the subsequent description of preferred embodiments, the drawing, and the claims.

### BRIEF DESCRIPTION OF THE DRAWINGS

The figure is a simplified view of a multiaxial vibration valve according to the invention, shown in partial section, illustrating a stand alone, in line, fluid flow control device that can operate in any axial plane, and it being understood that this invention is not limited to the precise arrangements and instrumentalities shown.

### DETAILED DESCRIPTION OF THE INVENTION

Referring to the figure, the multiaxial vibration valve according to the illustrated embodiment comprises a shell casing 20 and a flow chamber 21, wherein the lower portion of the flow chamber 26 is concavely shaped in which a control ball 24 is contained. The multiaxial vibration valve has an inlet port 22 and an outlet port 23. The interior diameter of the flow chamber 21 must exceed the diameter of the control ball 24, which is spherical in shape, to allow fluid to flow past the control ball to the outlet port 23 when the control ball is upset from the valve seat as will be described below. Between the lower section of the flow chamber 21 and the outlet port 23 a valve seat 25 is formed. The control ball is in moveable engagement with said valve seat, such that the diameter of the control ball must be greater than the diameter opening of the valve seat 25. A compressional spring 27, attached to the upper portion of the flow chamber 21 at one end, is connected to the control ball at the other end, such that said spring's compressional force is sufficient to push said control ball up against the valve seat 25 forming a tight seal when said multiaxial vibration valve device is at rest. When said multiaxial vibration valve is vibrated by an outside source, the compressional force of said spring allows the control ball to become dislodged from the valve seat, due to said control ball's inertia, and restricts the control ball's vibrating motion only to the lower concave portion 26 of the flow chamber 21, such that fluid present in the flow chamber can flow passed the control ball through the valve seat and out through the outlet port 23. When the vibrations from the outside source cease, said compressional spring, working in conjunction with the concavely shaped section of the lower chamber 26, guides the control ball back onto the valve seat, whereby restoring said seal and preventing the fluid present in the flow chamber 21 in flowing to the outlet port 23, thus automatically stopping the fluid flow. The valve seat 25 must be formed within necessary tolerances to allow the control ball 24 to seal with the valve seat 25 when the vibration valve is at rest. From the foregoing description it has been apparent that my new invention described herein provides a simple, automatic, highly practical, stand alone, in line device for controlling the flow of a fluid that can operate in any directional plane.

Let it be understood that the only operational limitation of the multiaxial vibration valve device might occur when said device is tilted in line more than 90° degrees from the vertical, such that the fluid may not flow from the inlet port 22 upwards into the flow chamber 21 due to gravity unless, the fluid is under a sufficient amount of pressure whereby, permitting the fluid to do so.

What I claim as my invention is:

1. A stand alone, fluid flow control device comprising a flow chamber with an inlet port and an outlet port, a valve seat between the interior volume of the flow chamber and the outlet port, a control ball in moveable engagement with said valve seat, such that said control ball is held stable relative to the valve seat by a compressional spring when the valve device is at rest, and allowed to move from the valve seat when the vibration valve device is moved by oscillations and vibrations from an outside source, allowing fluid present in the flow chamber to flow past the control ball, through the valve seat, and then through the outlet port.

2. A fluid flow control device as described in claim 1, wherein said device can operate in any position.

3. A compressional spring as described in claim 1, pushes the control ball against the valve seat with enough force to form a tight seal when said device is not being vibrated.

4. A compressional spring as described in claim 3 has a compressional force such that when the vibration valve device is vibrated by an outside source, said spring allows the control ball to disengage from the valve seat and move within the lower portion of the flow chamber.

5. The lower section of the fluid flow chamber as described in claim 4, is concavely shaped.

6. Said compressional spring as described in claim 4 guides the control ball along the lower concave surface of the flow chamber as described in claim 5 to the valve seat, forming a tight seal after the control valve device stops vibrating.

7. A stand alone, fluid flow control device that can operate in any axial plane, comprising a flow chamber with an inlet port and an outlet port, a valve seat between the interior volume of the flow chamber and the outlet port, a control ball in moveable engagement with said valve seat, and a compressional spring that holds the control ball up against said valve seat forming a seal between the flow chamber and the outlet port when said valve device is at rest, and allows said control ball to become dislodged from the valve seat when the valve device is accelerated by oscillations, allowing fluid present in the flow chamber to flow past the control ball through the valve seat and then through the outlet port, and when the device ceases to vibrate, said compression spring working in conjunction with the curved lower portion of the flow chamber, automatically repositions the control ball to the valve seat, restoring said seal and preventing the flow of the fluid.
